(19) United States
(12) Patent Application Publication
(10) Pub. No.: US 2023/0202588 A1
(43) Pub. Date: Jun. 29, 2023

(54) VEHICLE LOWER STRUCTURE

(71) Applicant: Honda Motor Co., Ltd., Tokyo (JP)

(72) Inventors: Naotaka MATSUI, Tokyo (JP); Nobuyuki SHIBUTANI, Tokyo (JP); Hiromasa OGAWA, Tokyo (JP)

(73) Assignee: Honda Motor Co., Ltd., Tokyo (JP)

(21) Appl. No.: 17/972,576

(22) Filed: Oct. 24, 2022

(30) Foreign Application Priority Data
Dec. 29, 2021 (CN) 202111638095.6

(51) Int. Cl. B62D 35/02; B62D 37/02

(52) U.S. Cl. CPC B62D 35/02; B62D 37/02

(57) ABSTRACT

The disclosure provides a vehicle lower structure, which is used to change the air resistance of the vehicle bottom. The vehicle lower structure includes: a plurality of strakes, disposed in front of a wheel when viewed from a front of the vehicle; and at least one strake of the plurality of strakes, disposed to be movable in an up-down direction. The vehicle lower structure includes: a plurality of strakes, disposed in front of a wheel when viewed from a front of the vehicle; and at least one strake of the plurality of strakes, disposed to be movable in a front-rear direction.

### CROSS-REFERENCE TO RELATED APPLICATION

This application claims the priority benefits of Chinese application no. 202111638095.6, filed on Dec. 29, 2021. The entirety of the above-mentioned patent application is hereby incorporated by reference herein and made a part of this specification.

### BACKGROUND

### Technical Field

The disclosure relates to a vehicle lower structure.

### Related Art

In recent years, with the restrictions of vehicle exhaust regulations and CO₂/fuel efficiency regulations, there is a demand for both clean engine exhaust and improved efficiency of fuel consumption, which strengthens the building of cities and human settlements in all countries, and strengthens the capacity to plan and mange inclusive and sustainable urban building and sustainable human settlements countries. All countries are therefore called upon to provide safe, affordable, accessible, and sustainable transport systems for all and to improve road safety, especially by expanding public transport. There is also a need to reduce the adverse per capita environmental impact of cities, including by paying special attention to air quality and general and other waste management. In the field of transportation, the vehicle manufacturing industry has an urgent need to develop technologies that address environmental issues and increase the rate of improvement in energy efficiency worldwide.

In the vehicle manufacturing industry of existing technology, for example, in Patent Literature 1 (JP2015-150913), as a device for reducing an air resistance of a vehicle, a device including an undercover (50 in FIG. 3 of Patent Literature 1) at a front portion of the vehicle; an air dam (40 in FIG. 3 of Patent Literature 1) mounted on a front bumper (30 in FIG. 3 of Patent Literature 1); and a deflector (60 of FIG. 3 of Patent Literature 1) positioned between the air dam and a front wheel house (6 of FIG. 3 of Patent Literature 1) has been proposed. In such a device, in front of the vehicle from the front wheel house, a lower surface opening of the front part of the vehicle is closed with a cover front part of the undercover, while the front side of the vehicle and the outside of the vehicle are surrounded by air dams, and the rear side of the vehicle is surrounded by the deflector, thereby forming a cavity portion that is open to the inside in a vehicle width direction and is fan-shaped when viewed from the bottom. Thus, the traveling wind from the front of the vehicle is rectified and the traveling wind is prevented from flowing behind the deflector. As a result, a negative pressure region is relatively formed behind the deflector, thereby reducing air resistance during traveling.

In the device for reducing the air resistance of a vehicle proposed in Patent Literature 1, the deflector is disposed between the air dam installed on the front bumper and the front wheel house, therefore, in the device described in Patent Literature 1, when the traveling wind from the front of the vehicle collides with the air dam, the air resistance will increase, and the traveling wind from the front of the vehicle will retreat toward the side of the vehicle, such that the wind retreating toward the side of the vehicle cannot effectively reduce the air resistance.

In addition, Patent Literature 2 (WO 2018/150667) proposes a vehicle air resistance reducing device. In Patent Literature 2, the proposed vehicle air resistance reducing device includes a deflector formed by two strakes, in which a passage for guiding the passage of the traveling wind forms an opening in front of the vehicle, and the two strakes are disposed in front of the front wheel of the vehicle.

However, in the related art, a vehicle lower structure capable of adjusting the air resistance of a vehicle bottom is required.

The disclosure provides a vehicle lower structure capable of adjusting the air resistance of the vehicle bottom, such that the adjustment of the air resistance of the vehicle bottom becomes very convenient, thereby greatly improving the adjustment effect of the air resistance of the vehicle bottom when the vehicle is running.

### SUMMARY

The disclosure provides a vehicle lower structure for changing an air resistance of a vehicle bottom, in which the vehicle lower structure includes: a plurality of strakes, disposed in front of a wheel when viewed from a front of a vehicle; and at least one strake of the plurality of strakes, disposed to be able to move in an up-down direction.

The disclosure further provides a vehicle lower structure for changing an air resistance of a vehicle bottom, in which the vehicle lower structure includes: a plurality of strakes, disposed in front of a wheel when viewed from a front of a vehicle; and at least one strake of the plurality of strakes, disposed to be able to move in a front-rear direction.

Moreover, in the disclosure, the vehicle lower structure further includes: a shutter member, sealing a front-to-rear movement region where the plurality of strakes move in the front-rear direction.

Moreover, in the disclosure, the plurality of the strakes are disposed to be able to move up and down and/or back and forth according to vehicle speed and/or vehicle running conditions.

### BRIEF DESCRIPTION OF THE DRAWINGS

FIG. 1 is a schematic diagram for illustrating an example in which an air resistance adjusting device is disposed in a vehicle lower structure according to an embodiment of the disclosure.

FIG. 2 is a schematic diagram illustrating an example of the air resistance adjusting device of FIG. 1 viewed from a vehicle bottom.

FIG. 3 is a schematic diagram of the air resistance adjusting device of FIG. 2.

FIG. 4 is a schematic diagram illustrating the air resistance adjusting device of FIG. 3 viewed from another view angle.

FIG. 5 is a schematic diagram illustrating an up-down drive portion and a front-rear drive portion that move a strake in the air resistance adjusting device of FIG. 3.

FIG. 6 is a partially enlarged diagram of FIG. 5.

FIG. 7 is a schematic diagram of a chain member of the front-rear drive portion of FIG. 5.

### DESCRIPTION OF THE EMBODIMENTS

According to the disclosure, the air resistance of the vehicle bottom can be conveniently adjusted by disposing the strakes to be able to move in the up-down direction individually and independently. Therefore, the adjustment effect of the air resistance of the vehicle bottom when the vehicle is running is greatly improved, thereby improving the quality of the vehicle.

According to the disclosure, the air resistance of the vehicle bottom can be conveniently adjusted by disposing the strakes to be able to move in the front-rear direction individually and independently. Therefore, the adjustment effect of the air resistance of the vehicle bottom when the vehicle is running is greatly improved, thereby improving the quality of the vehicle.

According to the described structure, the front-to-rear movement region of the strake in the front-rear direction is sealed or shielded by the configuration of the shutter member, when the strake is moved in the front-rear direction, the shutter member may correspondingly seal the vehicle bottom at the same time, and the front-to-rear movement region of the vehicle bottom does not form an opening when the strake moves in the front-rear direction.

According to the above configuration, the adjustment effect the air resistance of the vehicle bottom when the vehicle is running can be further improved, thereby improving the quality of the vehicle.

Based on the above, the vehicle lower structure of the disclosure can adjust the air resistance of the vehicle bottom. Moreover, different from the strakes in the prior art that are fixed and cannot be adjusted, the disclosure can make the adjustment of the air resistance of the vehicle bottom very convenient, thereby greatly improving the adjustment effect of the air resistance of the vehicle bottom when the vehicle is running. Further, the strakes are designed to be independently adjustable in the up-down direction, such that a protruding length of each of the strakes in the up-down direction (that is, the distance between a lower end of the strake and the ground) can be changed, and can also be adjusted in the front-rear direction, such that the position of the strake in the front-rear direction can be changed. Moreover, the adjustment of the strakes in the up-down direction and the front-rear direction can also be performed independently and selectively, such that the function of adjusting the air resistance of the vehicle bottom when the vehicle is running is greatly increased in convenience and flexibility, thereby improving the quality of the vehicle.

In order to make the above-mentioned features and advantages of the disclosure more obvious and easy to understand, the following specific embodiments are given and described in detail with reference to the accompanying drawings as follows.

Hereinafter, embodiments of the disclosure will be described based on the drawings. Note that in each embodiment demonstrated below, common parts are given the same reference numerals, and repeating descriptions are omitted. Hereinafter, embodiments of the disclosure will be described with reference to the accompanying drawings. In the embodiment described below, when referring to the number, amount, and the like, the scope of the disclosure is not necessarily limited to that particular number, amount, and the like, unless otherwise specified. Moreover, in the following embodiments, each constituent element is not necessarily essential to the disclosure, unless otherwise specified. Further, when there are a plurality of embodiments below, unless otherwise specified, it is established from the outset, that is, in advance, that the features of each embodiment can be appropriately combined.

The vehicle body panel structure including each embodiment of the disclosure will be described with reference to the drawings. FR in each drawing indicates a front direction in a front-rear direction of the vehicle, UP indicates an up direction in an up-down direction of the vehicle, and IN indicates an inner direction in a width direction of the vehicle. Moreover, the directions and positions described in the specification of the disclosure are defined on the premise that the front of the vehicle faces forward.

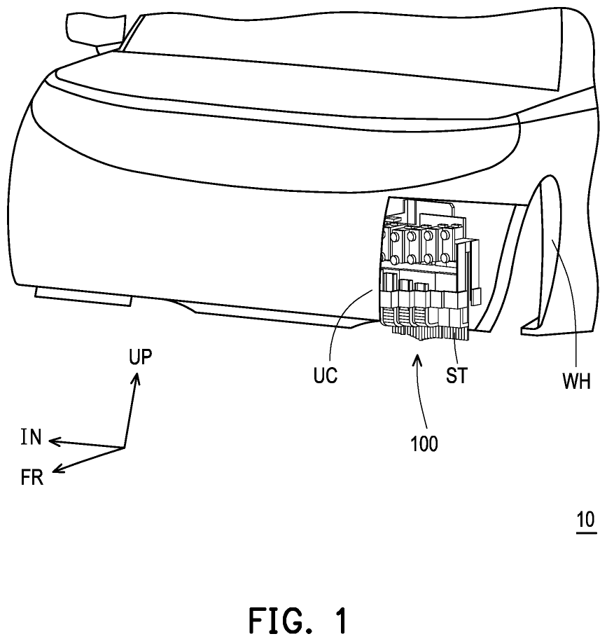

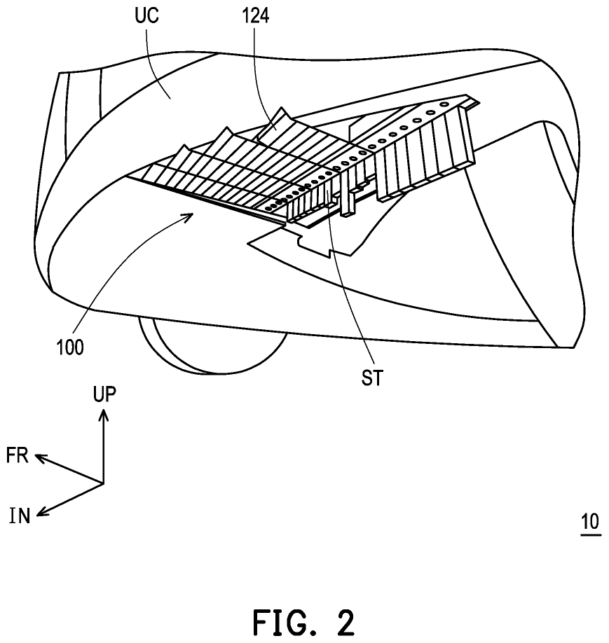

Hereinafter, embodiments of the disclosure will be described with reference to the accompanying drawings. The vehicle lower structure of this embodiment will be described with reference to the drawings. FIG. 1 is a schematic diagram for illustrating an example in which an air resistance adjusting device is disposed in a vehicle lower structure according to an embodiment of the disclosure. FIG. 2 is a schematic diagram illustrating an example of the air resistance adjusting device of FIG. 1 viewed from a vehicle bottom. As shown in FIGS. 1 and 2, a vehicle lower structure 10 includes an air resistance adjusting device 100 for adjusting or changing air resistance of the vehicle bottom. As shown in FIG. 1, the air resistance adjusting device 100 is a device that may adjust the air resistance caused by traveling wind from the front of the vehicle according to vehicle speed and/or traveling condition while the vehicle is running. FIG. 1 shows that the air resistance adjusting device 100 is disposed in front of a wheel house WH of a left front wheel. Note that although not shown, a right front wheel is symmetrically provided with the same air resistance adjusting device.

As shown in FIG. 1, the air resistance adjusting device 100 is configured to include a plurality of strakes ST arranged in a substantially left-right direction (the width direction of the vehicle). The plurality of strakes ST are disposed in front of the front wheels when viewed from the front of the vehicle, and at least one strake ST among the plurality of strakes ST is disposed so as to be movable in the up-down direction. By disposing the strake ST to be able to move in the up-down direction individually and independently, the air resistance of the vehicle bottom can be conveniently adjusted according to the vehicle speed and/or the driving conditions of the vehicle. Therefore, the adjustment effect of the air resistance of the vehicle bottom when the vehicle is running is greatly improved, thereby improving the quality of the vehicle.

Further, as shown in FIG. 1, at least one strake ST of the plurality of strakes ST of the air resistance adjusting device 100 is disposed so as to be movable in the front-rear direction. By disposing the strake ST to be able to move in the front-rear direction individually and independently, the air resistance of the vehicle bottom can be conveniently adjusted according to the vehicle speed and/or the vehicle running condition. Therefore, the adjustment effect of the air resistance of the vehicle bottom when the vehicle is running is greatly improved, thereby improving the quality of the vehicle.

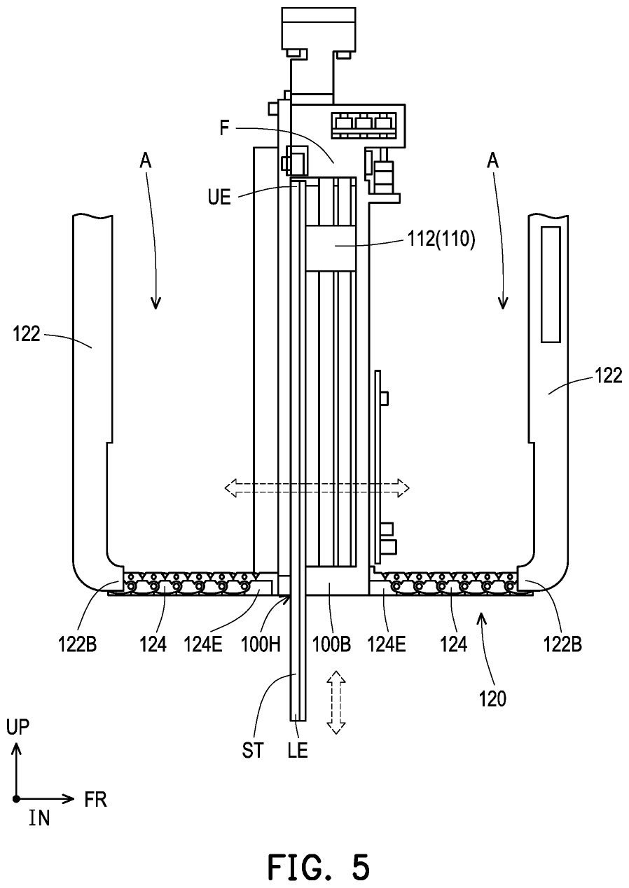

In this manner, the air resistance adjusting device 100 disposed in the vehicle lower structure 10 of the disclosure includes the plurality of strakes ST movable in the up-down direction and the front-rear direction, and strake ST may be moved independently according to the vehicle speed and/or the driving conditions of the vehicle, such that the air resistance of the vehicle bottom can be adjusted arbitrarily. Different from the fixed and unadjustable strakes in the prior art, the disclosure is capable of making the adjustment of the air resistance of the vehicle bottom very convenient, thereby greatly improving the adjustment effect of the air resistance of the vehicle bottom when the vehicle is running. Moreover, the strake ST is designed to be independently adjustable in the up-down direction, such that the protruding length of each of the strakes in the up-down direction, that is, the distance between a lower end LE of the strake ST and the ground, or the length of the lower end LE of the strake ST protruding downward from an opening 100H disposed in a base 100B of the air resistance adjusting device 100 (shown in FIG. 5 to be described later)) may be changed, and may also be adjusted in the front-rear directions, such that the position of each of the strakes ST may be changed in the front-rear direction. Further, the adjustment of the strake ST in the up-down direction and the front-rear direction may also be performed independently and selectively, such that the function of adjusting the air resistance of the vehicle bottom when the vehicle is running is greatly increased in convenience and flexibility, thereby improving the quality of the vehicle.

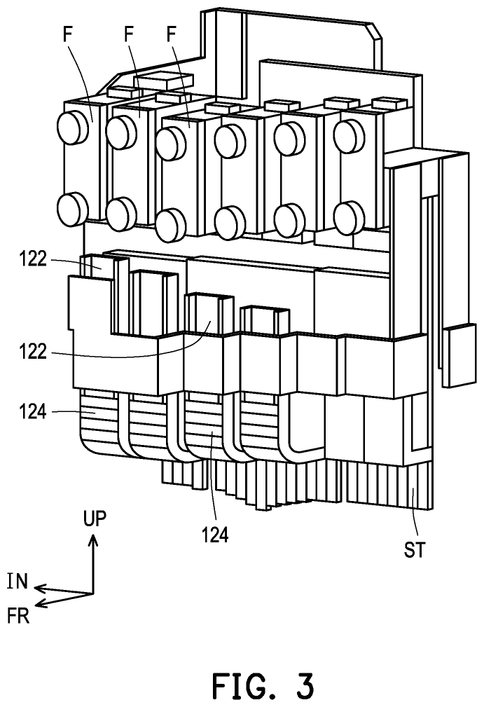

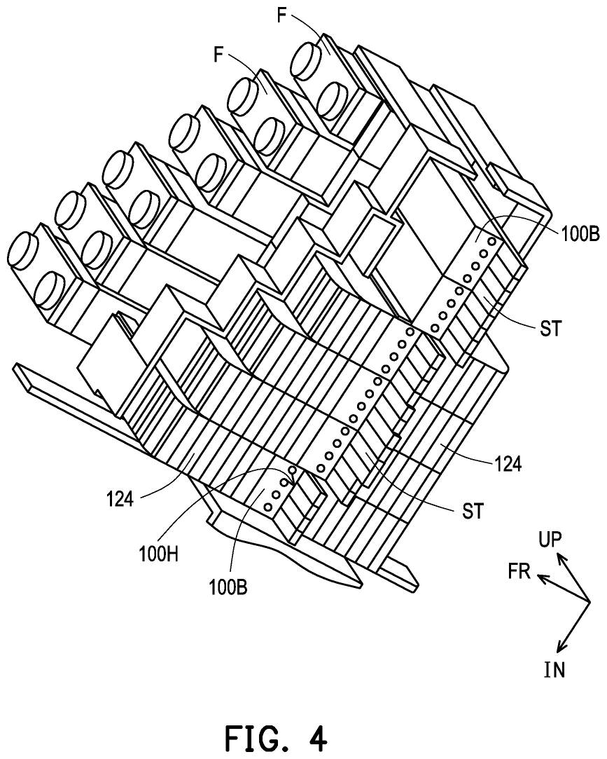

FIG. 3 is a schematic diagram of the air resistance adjusting device of FIG. 2. FIG. 4 is a schematic diagram illustrating the air resistance adjusting device of FIG. 3 viewed from another view angle. FIG. 5 is a schematic diagram illustrating an up-down drive portion and a front-rear drive portion that move a strake in the air resistance adjusting device of FIG. 3. As shown in FIGS. 1 to 5, in the air resistance adjusting device 100, each of the strakes ST is disposed, for example, as an elongated plate-shaped member or a strip-shaped member that protrudes downward in a vertical direction (up-down direction) from an undercover UC and extends in a width direction (left-right direction) of the vehicle. For example, the plurality of strakes ST are disposed in a row in the left-right direction. The size and number of the strakes ST are not limited in this embodiment, and the size and number of the strakes ST may be appropriately changed according to actual needs.

The air resistance adjusting device 100 includes an up-down drive portion 110 for moving the strake ST in the up-down direction, and a front-rear drive portion 120 for moving the strake ST in the front-rear direction. The up-down drive portion 110 of the air resistance adjusting device 100 includes a plurality of drive units 112, and each of the drive units 112 is disposed to be independently controllable by an electric drive device, for example, so as to move the drive the strake ST in the up-down direction. An upper end UE of each of the strakes ST is fixed to each of the drive units 112 and may be moved in the up-down direction by the drive of the drive unit 112, and each of the drive units 112 may be disposed on the vehicle lower structure 10 through a support F, for example.

As shown in FIGS. 4 and 5, the upper end UE of each of the strakes ST is fixed to each of the drive units 112, and the lower end LE is disposed to be able to extend downward from the opening 100H formed on the base 100B of the air resistance adjusting device 100 in the up-down direction. The protruding length of each of the strakes ST extending from the opening 100H formed on the base 100B may be adjusted by independently controlling each of the drive units 112, so as to be able to arbitrarily adjust the protruding length of each of the strakes ST according to the vehicle speed and/or the driving condition when the vehicle is running, thereby forming different air guiding functions (such as volume and direction of air flow). The drive unit 112 may be disposed as a linearly movable electric driving device composed of slide rails and sliders, but the disclosure is not limited to this, any mechanism capable of driving the strake ST to move in the up-down direction may be used.

As shown in FIGS. 4 and 5, the front-rear drive portion 120 of the air resistance adjusting device 100 is disposed on the base 100B such that each of the strakes ST may move in the front-rear direction. The front-rear drive portion 120 includes support stands 122, and a moving body 124 that may reciprocate on the support stand 122. The support stand 122 is, for example, fixed to the support F or also fixed to an appropriate position of the vehicle lower structure 100, and the support stand 122 is used to support the moving body 124 and allow the moving body 124 to reciprocate.

In this embodiment, the support stand 122 is disposed as an example of an L-shaped rigid member having a moving rail, and the moving body 124 may reciprocate in the moving rail. As shown in FIG. 5, the front-rear drive portion 120 are configured as follows: when viewed from one side in the left-right direction of the vehicle (for example, in a view angle of a plane including the front-rear direction and up-down direction of the vehicle), the support stand 122 formed of a rigid member is erected on a side of each of the strakes ST and each of the drive units 112 in a manner substantially parallel to the strake ST, the moving body 124 is configured to be extendable/retractable from the bottom portion 122B of the support stand 122, and the moving body 124 is configured to be connected between the bottom portions 122B of the L-shaped support stands 122 located on both sides of the strake ST.

In this manner, as shown in FIG. 5, the L-shaped support stands 122 located on both sides of the strake ST and the moving body 124 connected between the bottom portions 122B form a U-shaped structure. Moreover, as shown in FIG. 5, the moving body has ends 124E fixed to both sides of the base 100B, and the opening 100H formed in the base 100B is located between where the ends 124E of the moving body and the base 100B are fixed. Thus, when the moving body 124 is driven to move back and forth between the support stands 122 on both sides of the strake ST along the front-rear direction, the moving body 124 drives the strake ST to reciprocate in the front-rear direction between the support stands 122 like a conveyor.

As shown in FIG. 5, the space enclosed by the support stands 122 located on both sides of the strake ST and the moving body 124 connected between the bottom portions 122B of the support stands 122 is defined as a front-to-rear movement region A. In this manner, each of the strakes ST may move back and forth in the front-rear direction by the driving of the moving body 124 in the front-to-rear movement region A, greatly increasing the convenience and flexibility in adjusting the air resistance of the vehicle bottom when the vehicle is running, thereby improving the quality of the vehicle.

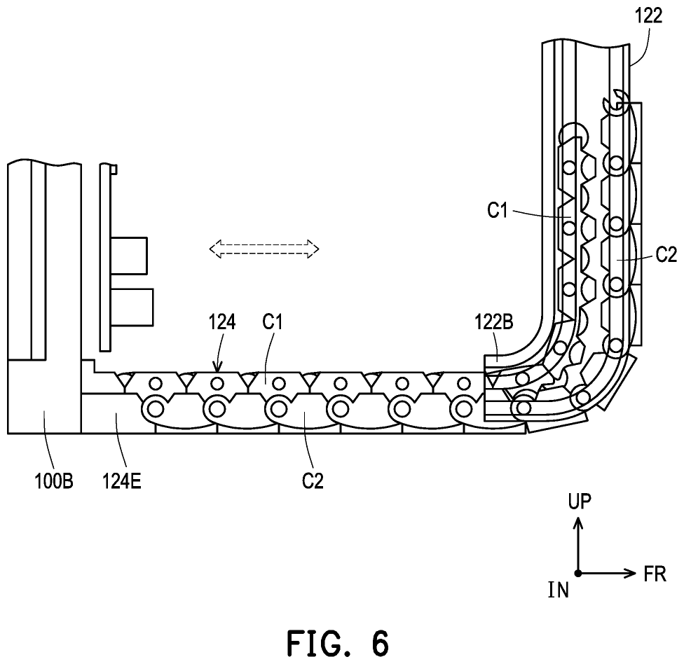

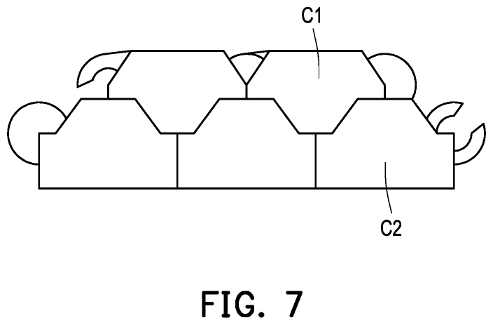

As shown in FIG. 5, the moving body 124 is constituted by, for example, a chain member. In this embodiment, a moving body 124 constituted by two chain members C1 and C2 is described as an example, but the disclosure is not limited to this. FIG. 6 is a partially enlarged diagram of FIG. 5. FIG. 7 is a schematic diagram of a chain member of the front-rear drive portion of FIG. 5. As shown in FIGS. 5 to 7, the moving body 124 includes the two chain members C1, C2. The two chain members C1, C2 are disposed such that: when the moving body 124 moves back and forth in the front-rear direction, the two chain members C1 and C2 of the moving body 124 located in the front-to-rear movement region A are overlapped and stacked in the up-down direction (this overlapped and stacked configuration will be referred to as a shutter member S to be described later), and the two chain members C1 and C2 of the moving body 124 located outside the front-to-rear movement region A, that is, the two chain members C1, C2 located in the region within the support stand 122 move within the support stand 122 from overlapping and stacked to being separated from each other. In this manner, the moving body 124 is configured such that the two chain members C1 and C2 are formed to have a certain degree of rigidity without bending when they are stacked, and are formed to have a certain degree of flexibility when they are separated (not stacked together), such that they can be properly bent (to be easily accommodated in the support stand 122 and moved). In other words, the moving body 124 has a structure capable of driving the strake ST to move in the front-rear direction, and has a structure capable of withstanding the pressure difference caused by the flowing wind of the vehicle bottom, thereby sealing the front-to-rear movement region A of the vehicle bottom.

As shown in FIGS. 6 and 7, in the air resistance adjustment structure 100, by disposing the moving body 124 composed of the two chain members C1 and C2, in the front-to-rear movement region A, the two chain members C1 and C2 are stacked and configured to form the shutter member S that seals or shields the front-to-rear movement region A in which the plurality of strakes ST move in the front-rear direction. In this manner, by the configuration of the shutter member S, the front-to-rear movement region A in which the strake ST moves in the front-rear direction is sealed; when moving the strake ST in the front-rear direction, the shutter member S may correspondingly seal the vehicle bottom at the same time, such that the front-to-rear movement region A of the vehicle bottom does not form an opening when the strake ST moves in the front-rear direction. In other words, the moving body 124 of the disclosure is configured to have a structure that may have both appropriate rigidity and flexibility, and can effectively use the limited space of the vehicle lower structure 10.

In this embodiment, the arrangement in which four strakes ST are disposed in one moving body 124 as one strake group is described as an example, but the disclosure is not limited thereto. In other words, as shown in FIG. 2, the moving body 124 is configured with four strakes ST, and when the moving body 124 is driven, the driven moving body 124 drives a strake group to move in the front-rear direction (that is, the four strakes ST configured move in the front-rear direction at the same time), and because each of the strakes ST is set to be independently driven in the up-down direction, so even if they are configured in the same strake group, each of the strakes ST may move independently in the up-down direction.

As shown in FIG. 2, FIG. 4 and FIG. 5, in this embodiment, there are a total of six strake groups, and each of the strakes group has four strakes ST. The four strake groups located on the inner side of the vehicle are provided on four moving bodies 124, and the two outermost strake groups are not provided with the moving body 124. Therefore, in the example given in this embodiment, all the strakes ST move independently in the up-down direction. Each of the strakes ST in the two outermost strake groups will not move back and forth, and each of the strakes ST in the inner four strake groups are capable of moving in the front-rear direction, but the disclosure is not limited thereto. The configuration may be made according to actual needs according to different styles of vehicles.

In summary, the vehicle lower structure of the disclosure can adjust the air resistance of the vehicle bottom. Different from the fixed and unadjustable strakes in the prior art, the disclosure is capable of making the adjustment of the air resistance of the vehicle bottom very convenient, such that the adjustment effect of the air resistance of the vehicle bottom when the vehicle is running is greatly improved. Moreover, the strakes are designed to be independently adjustable in the up-down direction, such that the protruding length of each of the strakes in the up-down direction (that is, the distance between the lower end of the strake and the ground) may be changed, or may be adjusted in the front-rear direction such that the position of the strake in the front-rear direction varies. Further, the adjustment of the strakes in the up-down direction and the front-rear direction can also be performed independently and selectively, such that the function of adjusting the air resistance of the vehicle bottom when the vehicle is running is greatly increased in convenience and flexibility, thereby improving the quality of the vehicle.

Moreover, the plurality of strakes may also be disposed to be movable up and down and/or back and forth in front of the rear wheels. According to this structure, by providing a plurality of strakes disposed so as to be individually movable in the up-down direction and/or the front-rear direction, not only in front of the front wheels, but also in front of the rear wheels, it is possible to further improve the adjustment effect of the air resistance at the vehicle bottom when the vehicle is running, thereby improving the quality of the vehicle.

Finally, it should be noted that the above embodiments are only used to illustrate the technical solutions of the disclosure, but not to limit them. Although the disclosure has been described in detail with reference to the foregoing embodiments, those of ordinary skill in the art should understand that: it is still possible to modify the technical solutions described in the foregoing embodiments, or perform equivalent replacements to some or all of the technical features. These modifications or substitutions do not make the essence of the corresponding technical solutions deviate from the scope of the technical solutions of the embodiments of the disclosure.

What is claimed is:

1. A vehicle lower structure, for changing an air resistance at a vehicle bottom, the vehicle lower structure comprising:
a plurality of strakes, disposed in front of a wheel when viewed from a front of a vehicle; and
at least one strake of the plurality of strakes, disposed to be movable in an up-down direction.

2. The vehicle lower structure according to claim 1,
wherein the plurality of the strakes are disposed to be able to move up and down and/or back and forth according to vehicle speed and/or vehicle driving conditions.

3. A vehicle lower structure, for changing an air resistance at a vehicle bottom, the vehicle lower structure comprising:
a plurality of strakes disposed in front of a wheel as viewed from a front of a vehicle; and
at least one strake of the plurality of strakes disposed to be movable in a front-rear direction.

4. The vehicle lower structure according to claim 3, further comprising:
a shutter member, sealing a front-to-rear movement region where the plurality of strakes move in the front-rear direction.

5. The vehicle lower structure according to claim 3,
wherein the plurality of the strakes are disposed to be able to move up and down and/or back and forth according to vehicle speed and/or vehicle driving conditions.

6. The vehicle lower structure according to claim 4,
wherein the plurality of the strakes are disposed to be able to move up and down and/or back and forth according to vehicle speed and/or vehicle driving conditions.
